(19) United States
(12) Patent Application Publication
(10) Pub. No.: US 2025/0156688 A1
(43) Pub. Date: May 15, 2025

(54) Rainfall prediction method, system, device and medium based on machine learning

(71) Applicant: Hubei University, Wuhan City (CN)

(72) Inventors: Xiang Wang, Wuhan City (CN); Cao Yuan, Wuhan City (CN); Wenjie Yin, Wuhan City (CN); Chen Zhou, Wuhan City (CN)

(73) Assignee: Hubei University, Wuhan City (CN)

(21) Appl. No.: 19/023,271

(22) Filed: Jan. 15, 2025

(30) Foreign Application Priority Data
Mar. 13, 2024 (CN) CN202410286746.7

(51) Int. Cl. G06N 3/0455; G06N 3/0464

(52) U.S. Cl. CPC G06N 3/0455; G06N 3/0464

(57) ABSTRACT

The present invention is a rainfall prediction method, system, device and medium based on machine learning, which relates to the field of meteorological prediction technology. It uses atmospheric precipitable water volume (PWV) data, rainfall data and related meteorological parameters to input into a trained rainfall prediction network, and realizes accurate prediction of rainfall through an improved Transformer model. The model includes an encoder, a decoder and a final output layer, wherein feature extraction is performed inside the encoder through a multi-head probabilistic sparse self-attention module and a distillation module, and the encoder output containing feature information is used as the input of the decoder. The decoder passes through the decoder mask multi-head probabilistic sparse self-attention layer, and performs a multi-head self-attention operation with the intermediate result output by the encoder, and finally adjusts the data output dimension through a fully connected layer to generate a prediction result.

### CROSS-REFERENCE TO RELATED APPLICATION

This application claims priority to Chinese Application No. 202410286746.7, filed on Mar. 13, 2024, incorporated herein by reference in their entirety

### TECHNICAL FIELD

The present invention relates to the field of meteorological forecasting technology, and in particular to a rainfall forecasting method, system, device and medium based on machine learning.

### BACKGROUND ART

Existing rainfall prediction methods can be roughly divided into three categories: prediction methods based on deterministic models, prediction methods based on traditional statistics, and prediction methods based on machine learning. Prediction methods based on deterministic models mainly rely on physical principles and meteorological knowledge, and simulate processes such as water vapor movement, condensation, and precipitation in the atmosphere through numerical simulation and mathematical equations. The construction of such prediction models is relatively complex and the prediction accuracy is not high. Prediction methods based on traditional statistics focus on analyzing patterns and laws in historical observation data and making predictions by establishing mathematical models. However, they have certain limitations in dealing with complex meteorological processes, nonlinear relationships, and predictions of special events. Prediction methods based on machine learning use computer algorithms to learn patterns in historical observation data and predict future rainfall based on the learned models. These methods can handle complex nonlinear relationships and high-dimensional data and have strong flexibility and generalization capabilities.

At present, most of the machine learning methods widely used for rainfall time series prediction are based on recurrent structure networks, such as RNN and LSTM. Although this type of model can better solve the sequence prediction problem than other deterministic and traditional statistical models, it is prone to gradient vanishing and gradient exploding problems because it extracts time series information sequentially and continuously passes it backwards, making the model difficult or impossible to train.

How to more effectively learn the complex nonlinear relationship between rainfall and other influencing factors and ultimately improve the accuracy of rainfall forecasting has become the main problem to be overcome.

### SUMMARY OF THE INVENTION

In order to overcome the shortcomings of the above-mentioned prior art that the complex nonlinear relationship between rainfall and other influencing factors cannot be effectively learned, the main purpose of the present invention is to provide a rainfall prediction method based on machine learning.

To achieve the above object, the present invention adopts the following technical scheme, a rainfall prediction method based on machine learning, characterized in that it comprises the following steps:

A rainfall prediction model based on machine learning is constructed, and the rainfall prediction model includes an encoder, a decoder and a fully connected layer; wherein the encoder is used to encode meteorological sequence data (i.e. historical weather data) and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; the fully connected layer is used to adjust the long-distance dependent features processed by the convolutional attention layer of the decoder, and set the output latitude of the data after the multi-head attention layer to 1;

Collect meteorological data and obtain serial data about meteorology;

Input meteorological sequence data into the rainfall prediction model to obtain rainfall prediction results.

The encoder includes a multi-head probabilistic sparse self-attention module and a distillation module. The multi-head probabilistic sparse self-attention module extracts and compresses features of input sequence data to obtain dependency features between input data. The distillation module distills the information in the encoder's self-attention layer to extract key features.

The decoder includes a convolutional attention module and a multi-head attention mechanism; the convolutional attention module calculates the encoded input sequence to obtain high-level features and captures neighbor dependency features to obtain an intermediate variable that is further input into the decoder to process the data; the intermediate variable is input into the multi-head attention mechanism to capture long-distance dependency features;

The long-distance dependency features are projected to the original dimension of the time series through a fully connected layer to obtain the output of the decoder.

The fully connected layer includes:

Select a length of the input long sequence as Lₜₒₖₑₙ a time series, which is an earlier sequence before the output long sequence;

Taking β the time series with an input time point length X as an example, X={sₜ_{_{α30 1}}, sₜ_{_{α+2}}, . . . , sₜ_{_{α+168}}}, the generative reasoning will take the 128 time points before the known target sequence as token, and X_{feed}={sₜ_{₁}, sₜ_{₂}, . . . , sₜ_{_{α}}}, pass it back to the decoder, wherein sᵢ represents the ith time series of the moment.

Meteorological data include atmospheric precipitable water volume PWV data, rainfall data, and temperature, humidity, and pressure data.

The machine learning-based rainfall prediction system includes:

A data collection module, which collects meteorological data and obtains sequence data about meteorology;

A data processing module, which builds a rainfall prediction model based on machine learning, including an encoder, a decoder, and a fully connected layer. The input sequence data about the weather is processed by the encoder to obtain the dependency feature data between the encoded input sequence and the data. The decoder receives the feature data passed in by the encoder, processes it through masked multi-head probabilistic sparse self-attention, and then combines it with the encoded input sequence for multi-head self-attention processing to obtain long-distance dependency features.

A result prediction module, based on the acquired long-distance dependency features, adjusts the output latitude of the data after passing through the decoder convolutional attention layer and the multi-head attention layer to 1 through the fully connected layer, that is, generates the rainfall prediction result.

A computer device, characterized in that the computer device comprises a memory and a processor, the memory stores a computer program, and when the computer program is executed by the processor, the processor executes the following steps:

A rainfall prediction model based on machine learning is constructed, and the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; the fully connected layer is used to adjust the long-distance dependent features processed by the convolutional attention layer of the decoder, and set the output latitude of the data after the multi-head attention layer to 1;

Collect meteorological data and obtain serial data about meteorology;

Input meteorological sequence data into the rainfall prediction model to obtain rainfall prediction results.

A computer-readable storage medium stores a computer program, and when the computer program is executed by a processor, the processor executes the following steps:

A rainfall prediction model based on machine learning is constructed, and the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; the fully connected layer is used to adjust the long-distance dependent features processed by the convolutional attention layer of the decoder, and set the output latitude of the data after the multi-head attention layer to 1;

Collect meteorological data and obtain serial data about meteorology;

Input meteorological sequence data into the rainfall prediction model to obtain rainfall prediction results.

Compared with the prior art, the beneficial effects of the present invention are as follows: the present invention constructs a rainfall prediction model based on machine learning, and through the encoder-decoder architecture and the design of the fully connected layer, it can effectively capture the dependencies and feature information in the meteorological data. The application of the head probability sparse self-attention module and the distillation module in the encoder helps to extract and compress the dependency features of the input data, thereby improving the model's ability to characterize meteorological data. The convolutional attention module and the multi-head attention mechanism in the decoder can capture the dependencies of different time steps, including neighbor dependency features and long-distance dependency features, thereby improving the model's ability to model time series data. And the design of the fully connected layer enables the model to flexibly adjust and process the long-distance dependency features extracted in the encoder and decoder, and at the same time, the output latitude of the multi-head attention layer is set to 1 to obtain the final rainfall prediction result.

The rainfall prediction model in the present invention uses atmospheric precipitable water volume PWV data, rainfall data, and various meteorological data such as temperature, humidity, and pressure for prediction, thereby improving the model's ability to accurately predict rainfall. By integrating the complex architecture of encoders and decoders, and the comprehensive use of various meteorological data, the method can more accurately predict rainfall. It can handle dependencies of different time steps, so that the dynamic changes of meteorological data are taken into account during the prediction process, improving the stability and accuracy of the prediction. The application of the multi-head probabilistic sparse self-attention module and the distillation module enables the model to better extract and compress the dependency features of the input data, thereby improving the generalization ability and prediction performance of the model.

In general, the rainfall prediction method based on machine learning in the present invention has significant technical advantages in processing meteorological data, modeling dependencies, and prediction accuracy, and is expected to play an important role in meteorological forecasting and related fields.

### BRIEF DESCRIPTION OF THE DRAWINGS

FIG. 1 is a schematic diagram of the structure of the present invention;

FIG. 2 is a rainfall prediction diagram of the pre-trained model of the present invention in the test set;

FIG. 3 is a comparison diagram of the predicted rainfall and the actual rainfall at the Hankou site in some embodiments of the present invention;

FIG. 4 is a comparison diagram of the predicted rainfall and the actual rainfall at some land water reservoir sites in the embodiment of the present invention;

FIG. 5 is a comparison diagram of the predicted rainfall and the actual rainfall at Chenglingji site in some embodiments of the present invention;

FIG. 6 is a comparison diagram of the predicted rainfall and the actual rainfall at Juwan Station in some embodiments of the present invention;

FIG. 7 is a comparison diagram of the predicted rainfall and the actual rainfall at some Yidu stations in the embodiment of the present invention;

FIG. 8 is a rainfall prediction diagram of the T430 site data training model in the test set of the embodiment of the present invention;

FIG. 9 is a rainfall prediction diagram of the test set of the training model of the King's Park data of the KP site in the embodiment of the present invention;

FIG. 10 is a rainfall prediction diagram of the test set of the HKA site data training model in the embodiment of the present invention;

FIG. 11 is a rainfall prediction diagram of the test set of the Ping Chau data training model for some pen sites in an embodiment of the present invention.

### DETAILED DESCRIPTION

The present invention will be further described below in conjunction with the accompanying drawings and implementation modes.

### Example 1

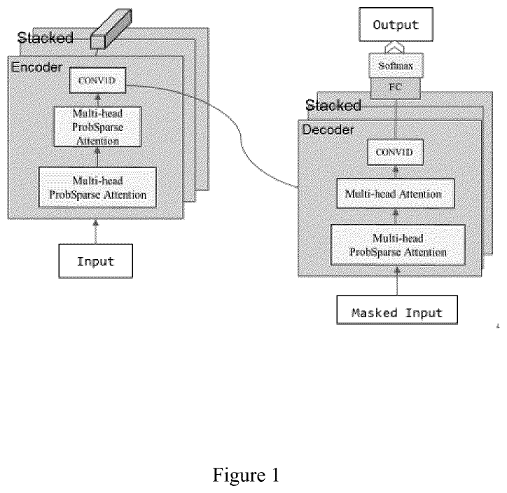

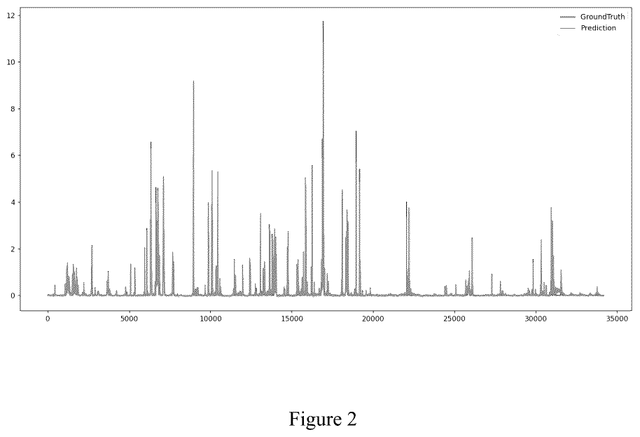

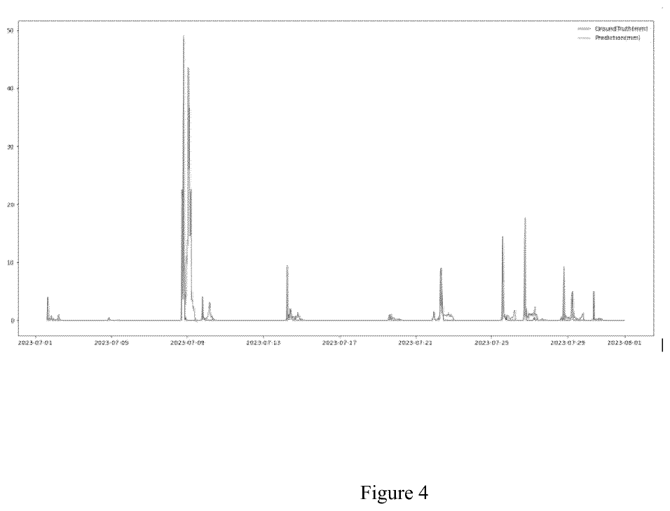

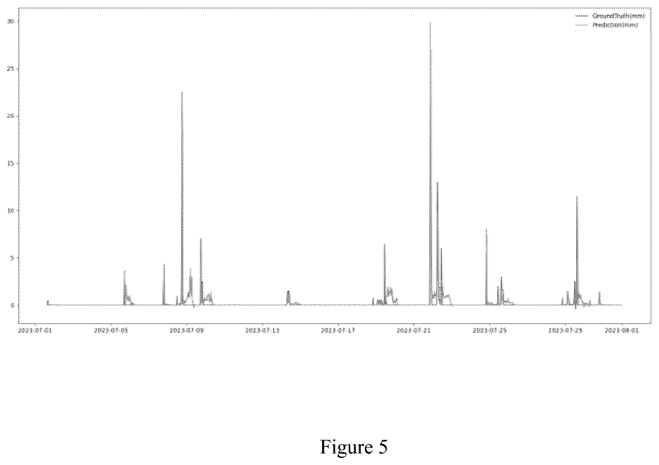

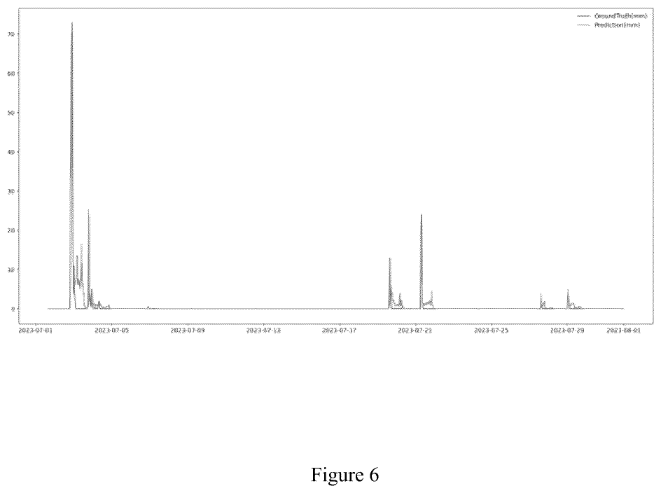

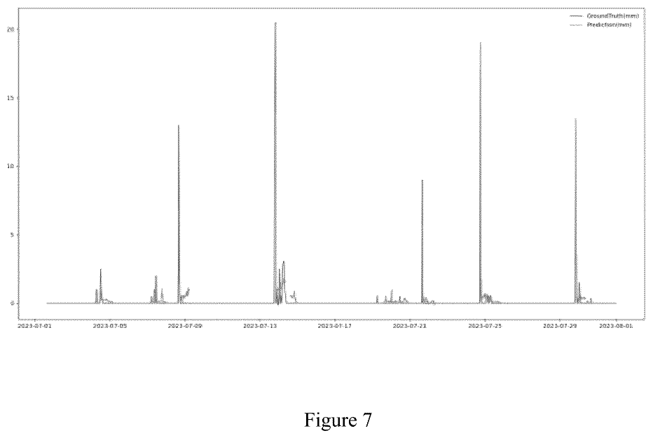

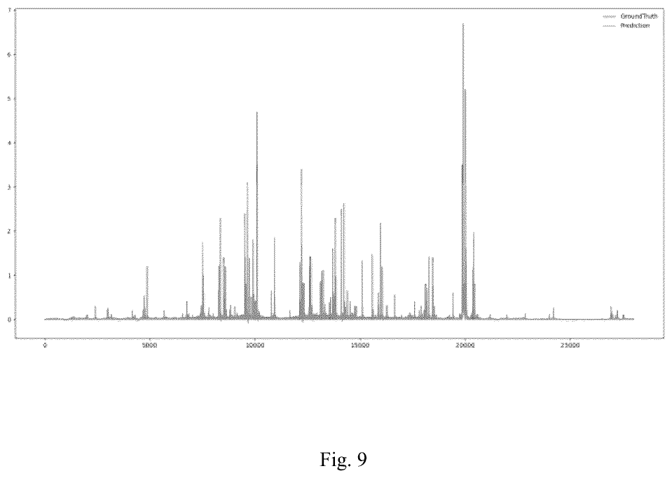

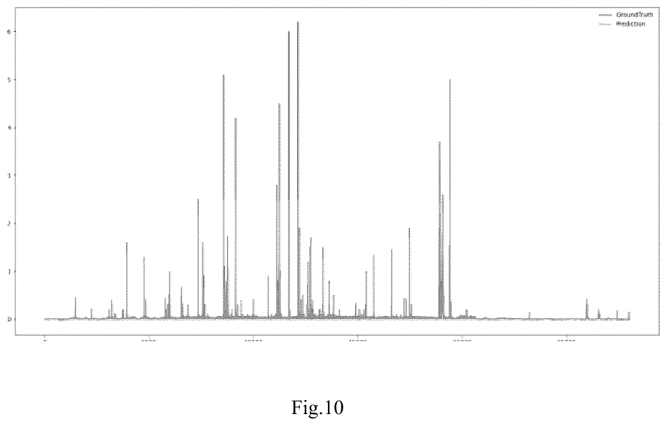

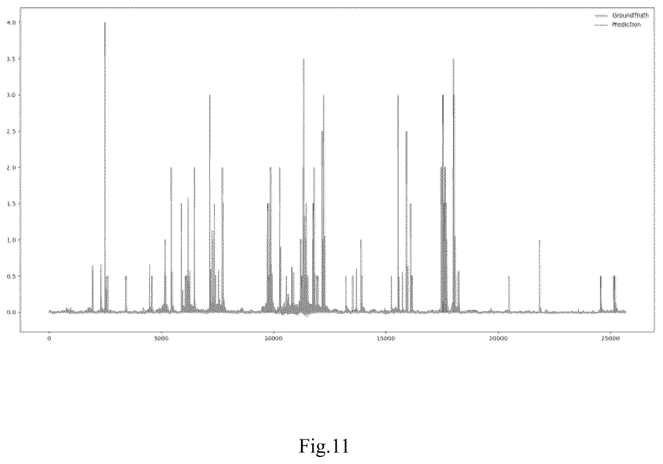

Combined with FIG. 1-11, the rainfall prediction method based on machine learning includes the following steps:

A rainfall prediction model based on machine learning is constructed, and the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; the fully connected layer is used to adjust the long-distance dependent features processed by the convolutional attention layer of the decoder, and set the output latitude of the data after the multi-head attention layer to 1;

Collect meteorological data and obtain serial data about meteorology;

Input meteorological sequence data into the rainfall prediction model to obtain rainfall prediction results.

The encoder includes a multi-head probabilistic sparse self-attention module and a distillation module. The multi-head probabilistic sparse self-attention module extracts and compresses the input sequence data to obtain the dependency features between the input data. The distillation module distills the information in the encoder's self-attention layer to extract key feature information.

The decoder consists of a convolutional attention module, a multi-head attention mechanism and a fully connected layer; the convolutional attention module calculates the encoded input sequence to obtain high-level features, while capturing neighbor dependency features to obtain an intermediate variable that is further input into the decoder to process the data; the intermediate variable is input into the multi-head attention mechanism to capture long-distance dependency features, and is projected to the original dimension of the time series through the fully connected layer to obtain the output of the decoder.

The fully connected layer includes: selecting a length of a time series from the input long sequence time series Lₜₒₖₑₙ, which is an earlier sequence before the output long sequence time series;

Taking β the time series with an input time point length X as an example, X={sₜ_{_{α+1}}, sₜ_{_{α+2}}, . . . , sₜ_{_{α+168}}}, the generative reasoning will take the 128 time points before the known target sequence as token, and X_{feed}={sₜ_{₁}, sₜ_{₂}, . . . , sₜ_{_{α}}}, pass it back to the decoder, wherein sᵢ represents the ith time series of the moment.

Meteorological data include atmospheric precipitable water volume PWV data, rainfall data, and temperature, humidity, and pressure data.

The machine learning-based rainfall prediction system includes:

Data collection module, collects meteorological data and obtains sequence data about meteorology;

The data processing module builds a rainfall prediction model based on machine learning, including an encoder, a decoder, and a fully connected layer. The input sequence data about the weather is processed by the encoder to obtain the dependency feature data between the encoded input sequence and the data. The decoder receives the feature data passed in by the encoder, processes it through masked multi-head probabilistic sparse self-attention, and then combines it with the encoded input sequence for multi-head self-attention processing to obtain long-distance dependency features.

The result prediction module, based on the acquired long-distance dependency features, adjusts the output latitude of the data after passing through the decoder convolutional attention layer and the multi-head attention layer to 1 through the fully connected layer, that is, generates the rainfall prediction result.

A computer device includes a memory and a processor, wherein the memory stores a computer program, and when the computer program is executed by the processor, the processor executes the following steps:

A rainfall prediction model based on machine learning is constructed, and the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; the fully connected layer is used to adjust the long-distance dependent features processed by the convolutional attention layer of the decoder, and set the output latitude of the data after the multi-head attention layer to 1;

Collect meteorological data and obtain serial data about meteorology;

Input meteorological sequence data into the rainfall prediction model to obtain rainfall prediction results.

A computer-readable storage medium stores a computer program. When the computer program is executed by a processor, the processor executes the following steps:

A rainfall prediction model based on machine learning is constructed, and the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; the fully connected layer is used to adjust the long-distance dependent features processed by the convolutional attention layer of the decoder, and set the output latitude of the data after the multi-head attention layer to 1;

Collect meteorological data and obtain serial data about meteorology;

Input meteorological sequence data into the rainfall prediction model to obtain rainfall prediction results.

### Embodiment 2

On the basis of Example 1, in this embodiment, atmospheric precipitable water volume PWV data, rainfall data and related meteorological parameters, including temperature, humidity and pressure data, are input into the trained rainfall prediction network to obtain the prediction result. The rainfall prediction network is trained based on the network training data set, wherein the data set used for training is the era5 data set of the Jiufeng site, and the data used for actual measurement is the actual measurement equipment set arranged by the Wuhan University laboratory and the Hong Kong data; the improved transformer model includes an encoder, a decoder and an output layer.

Among them, according to the input atmospheric precipitable water volume PWV data, rainfall data and related meteorological parameters, the feature extraction of the multi-head probabilistic sparse self-attention module and the distillation module is carried out inside the encoder, and the encoder output containing feature information is used as the input of the decoder, and passes through the decoder masked multi-head probabilistic sparse self-attention layer, and then performs a multi-head self-attention operation with the intermediate result of the encoder output, and finally adjusts the data output latitude through the fully connected layer to generate the prediction result in one step; in this way, the atmospheric precipitable water volume PWV data, rainfall data and related meteorological parameters are used to assist the network to pay attention to the part of the data containing the target structure, thereby improving the performance of the model for rainfall prediction, and has a good prediction effect.

ERA5 is a global meteorological dataset released by the European Centre for Medium-Range Weather Forecasts (ECMWF). It provides high-resolution meteorological data worldwide, including temperature, precipitation, wind speed, humidity and other meteorological elements, with an hourly time resolution. The ERA5 dataset covers the period from 1979 to the present, and is one of the longest time series global reanalysis datasets currently available. It is based on advanced physical models and data assimilation techniques, and uses a variety of observational data sources, including satellite observations, meteorological station observations and buoy observations, to provide the most accurate and reliable meteorological data. The ERA5 dataset is widely used in climate research, weather forecasting, environmental monitoring, water resources management and other fields.

In the absence of historical data, a generalized deep learning model is trained using the ERA5 data training set. After pre-training and fine-tuning, the model is deployed in the actual measurement site.

The pre-training used data from the era5 Jiufeng station. The explanation for the pre-training is that the climate is diverse around the world, and the rainfall conditions in different regions vary significantly. Traditional rainfall prediction models are usually trained based on a dataset from a certain region, but due to differences in regional meteorological characteristics and the scarcity of stations in some regions, the generalization of rainfall prediction models is not strong, especially when previous historical data cannot be obtained.

To solve this problem, the rainfall prediction model uses pre-training fine-tuning technology. Pre-training fine-tuning technology is a method that uses a model pre-trained on a large-scale dataset and then fine-tunes it on the target task. In terms of surface rainfall prediction, first pre-training is performed on rainfall data using ERA5 for a large area, and then fine-tuning is performed on the target area or station to adapt to local meteorological characteristics.

The process of pre-training and fine-tuning is as follows: In the pre-training stage, large-scale regional meteorological data is used for pre-training; the rainfall prediction model learns the meteorological characteristics, correlations and laws within the region. In the fine-tuning stage, the pre-trained rainfall prediction model is fine-tuned using the local meteorological data of the target area or station; the rainfall prediction model gradually adapts to the meteorological characteristics of the target area through fine-tuning.

By using pre-training and fine-tuning techniques, the rainfall prediction model has stronger generalization capabilities and can capture the commonalities of different regions; it solves the problem that the rainfall prediction model cannot better adapt to local meteorological characteristics and improves prediction accuracy; it alleviates the site sparsity problem; the pre-trained rainfall prediction model is trained using large-scale data, while the fine-tuning stage is performed on a relatively small target data set, which also saves computing resources and improves efficiency.

By using pre-training and fine-tuning techniques to train the weights of the top output layer of the network, we can obtain a neural network model suitable for surface rainfall prediction tasks.

The steps of the surface rainfall prediction model based on pre-training and fine-tuning are as follows:

(1) Obtain the dataset of the target task, ensure that the dataset contains the input and the corresponding target label, and preprocess the data to ensure that the data format matches the input format of the pre-trained model;

(2) Load the built source data model and load the weight values trained on the ERA5 dataset;

(3) Freeze the weights of all other layers, release the weights of the output layer, use the enhanced data to train the neural network, and only update the weights of the output layer for fine-tuning;

(4) Select the root mean square error of the loss function and the optimizer;

(5) Perform fine-tuning iterative training using the target task dataset; iterate through the dataset, calculate the loss, and update the weights of the rainfall prediction model through back propagation.

(6) After fine-tuning on the training set, use the validation set or test set to evaluate the rainfall prediction model and check its performance in surface rainfall prediction. According to the evaluation results, adjust the learning rate, number of iterations and other hyperparameters to optimize the model performance. Finally, the trained model is obtained and saved.

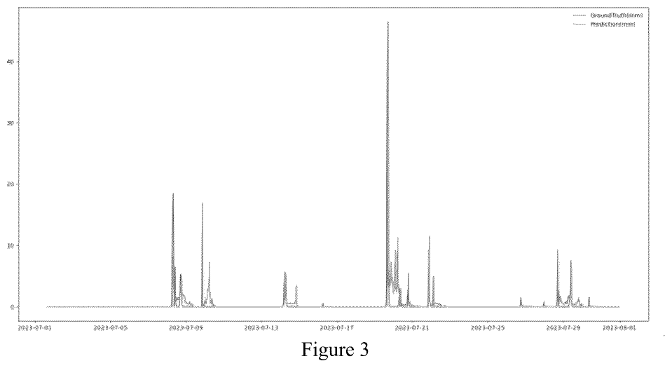

In the rainstorm season, the short-term rainfall intelligent prediction model of Beidou satellite navigation signals developed independently was used to conduct experiments in Wuhan and Sanmenxia, and the application of the short-term rainfall intelligent prediction technology of Beidou satellite navigation signals was optimized and verified. Through the trained model, rainfall prediction experiments have been carried out at multiple stations such as Hankou Station, Lushui Reservoir Station, Chenglingji Station, Juwan Station, and Yidu Station. Some results are shown in FIGS. 3-7:

Hong Kong has abundant rainfall. Located on the coast of the South China Sea, Hong Kong has a subtropical humid climate and is greatly affected by the Asian summer monsoon. As one of the main low-level monsoon currents, the ASM from the South China Sea transports a large amount of water vapor to Hong Kong during its occurrence.

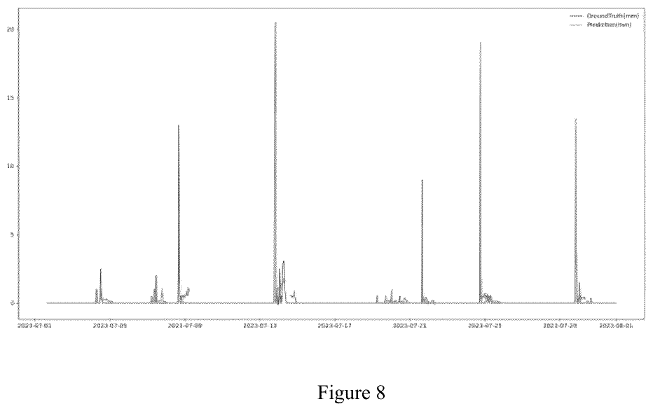

In summer, Hong Kong often experiences severe weather events such as hail, thunderstorms, typhoons, and increased heavy precipitation events. According to the precipitation intensity standard defined by the World Meteorological Organization, a heavy precipitation event is considered precipitation if the hourly precipitation falls between 10 mm and 50 mm or the daily precipitation is above 50 mm. According to this definition, based on the records of the Hong Kong Observatory from 1885 to 2019 (excluding 1940-1946), more than 56% of heavy precipitation occurs in the summer, June, July, and August in the northern hemisphere). Therefore, this embodiment mainly uses the heavy precipitation data occurring in Hong Kong for verification. The model training and verification were performed on the data of several stations in Hong Kong, and the results are shown in FIGS. 8-11 below:

It should be noted that, in the present invention, relational terms such as first and second, etc. are only used to distinguish one entity or operation from another entity or operation, and do not necessarily require or imply any such actual relationship or order between these entities or operations. Moreover, the terms “include”, “comprises” or any other variations thereof are intended to cover non-exclusive inclusion, so that a process, method, article or device including a series of elements includes not only those elements, but also other elements not explicitly listed, or also includes elements inherent to such process, method, article or device.

The above embodiments are merely examples of the present invention and do not limit the protection scope of the present invention. All designs that are the same or similar to the present invention fall within the protection scope of the present invention.

1. A rainfall prediction method based on machine learning, characterized in that it comprises the following steps:
Constructing a rainfall prediction model based on machine learning, wherein the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; wherein the fully connected layer is used to adjust the long-distance dependent features processed by the convolutional attention layer of the decoder, and set the output latitude of the data after the multi-head attention layer to 1;
Collecting meteorological data and obtaining serial data about meteorology;
Inputting meteorological sequence data into the rainfall prediction model to obtain rainfall prediction results.

2. The method according to the rainfall prediction method based on machine learning of claim 1, characterized in that the encoder includes a multi-head probabilistic sparse self-attention module and a distillation module, the multi-head probabilistic sparse self-attention module performs feature extraction and compression on the input sequence data to obtain the dependency features between the input data, and the distillation module distills the information in the encoder self-attention layer to extract key features.

3. The method according to the rainfall prediction method based on machine learning in claim 1, it is characterized in that the decoder includes a convolutional attention module and a multi-head attention mechanism; the convolutional attention module calculates the encoded input sequence to obtain high-level features and captures neighbor dependency features to obtain an intermediate variable that is further input into the decoder to process data; and the intermediate variable is input into the multi-head attention mechanism to capture long-distance dependency features;
Wherein, the long-distance dependency features are projected to the original dimension of the time series through a fully connected layer to obtain the output of the decoder.

4. The rainfall prediction method based on machine learning according to claim 1, characterized in that the fully connected layer comprises:
Select a length of the input long sequence as Lₜₒₖₑₙ a time series, which is an earlier sequence before the output long sequence;
Wherein, taking the time series β, with an input time point length X, wherein X={sₜ_{_{α+1}}, sₜ_{_{α+2}}, . . . , sₜ_{_{α+168}}}, the generative reasoning will take 128 time points before the known target sequence as token, wherein X_{feed}={sₜ_{₁}, sₜ_{₂}, . . . , sₜ_{_{α}}}, pass it back to the decoder, wherein sᵢ represents the ith time series of the moment.

5. The rainfall prediction method based on machine learning according to claim 1, characterized in that the meteorological data includes atmospheric precipitable water volume (PWV) data, rainfall data, and temperature, humidity, and pressure data.

6. A rainfall prediction system based on machine learning capable of performing the method of claim 1, comprising:
A data collection module, capable of collecting meteorological data and obtaining sequence data about meteorology;
A data processing module capable of building a rainfall prediction model based on machine learning, including an encoder, a decoder, and a fully connected layer, wherein input weather sequence data is processed by the encoder to obtain dependency feature data between encoded input sequence and the data, wherein the decoder receives feature data passed in by the encoder, processes it through masked multi-head probabilistic sparse self-attention, and then combines it with the encoded input sequence for multi-head self-attention processing to obtain long-distance dependency features;
A result prediction module, based on the acquired long-distance dependency features, which is capable of adjusting the output latitude of the data after passing through the decoder convolutional attention layer and the multi-head attention layer to 1 through the fully connected layer, generating the rainfall prediction result.

7. A computer device, characterized in that the computer device comprises a memory and a processor, wherein the memory is capable of storing a computer program, and when the computer program is executed by the processor, the processor executes the following steps:
Constructing a rainfall prediction model based on machine learning, wherein the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; wherein the fully connected layer is used to adjust the long-distance dependent features processed by the convolutional attention layer of the decoder, and set the output latitude of the data after the multi-head attention layer to 1;
Collecting meteorological data and obtaining serial data about meteorology;
Inputting meteorological sequence data into the rainfall prediction model to obtain rainfall prediction results.

8. A computer-readable storage medium, characterized in that the computer-readable storage medium stores a computer program, and when the computer program is executed by a processor, the processor executes the following steps:
Constructing a rainfall prediction model based on machine learning, wherein the rainfall prediction model includes an encoder, a decoder and a fully connected layer; wherein the encoder is used to encode the meteorological sequence data and extract the encoded dependent feature data; the decoder is used to perform masked multi-head probabilistic sparse self-attention processing on the dependent feature data, and perform multi-head self-attention processing in combination with the encoded input sequence data, thereby obtaining long-distance dependent feature data; wherein the fully connected layer is used to adjust the long-distance dependent features processed by the convolutional attention layer of the decoder, and set the output latitude of the data after the multi-head attention layer to 1;
Collecting meteorological data and obtaining serial data about meteorology;
Inputting meteorological sequence data into the rainfall prediction model to obtain rainfall prediction results.
